(19) United States
(12) Patent Application Publication
(10) Pub. No.: US 2017/0039278 A1
(43) Pub. Date: Feb. 9, 2017

(54) ANNOTATING SOCIAL GRAPH EDGES WITH INTEREST GRAPH INFORMATION

(71) Applicant: Google Inc., Mountain View, CA (US)

(72) Inventors: Gregory Matthew Marra, San Francisco, CA (US); Frances Bordwell Haugen, Mountain View, CA (US)

(73) Assignee: Google Inc., Mountain View, CA (US)

(21) Appl. No.: 14/028,898

(22) Filed: Sep. 17, 2013

Related U.S. Application Data
(60) Provisional application No. 61/746,059, filed on Dec. 26, 2012.

(51) Int. Cl. G06F 17/30

(52) U.S. Cl. CPC G06F 17/30861

(57) ABSTRACT

A method includes determining whether a social interaction between a first user and a second user includes a shared interest, where the shared interest identifies an interest about which the first user and the second user communicate in the social interaction, identifying a social relationship between the first user and the second user based at least on the social interaction, when the social interaction includes a shared interest, and associating the shared interest with the identified social relationship by referencing the shared interest in the identified social relationship between the first user and the second user.

### CROSS-REFERENCE TO RELATED APPLICATIONS

The present application claims the benefit of priority under 35 U.S.C. §119 from U.S. Provisional Patent Application Ser. No. 61/746,059, filed on Dec. 26, 2012, the disclosure of which is hereby incorporated by reference in its entirety for all purposes.

### BACKGROUND

Two users of a social networking site may interact with each other on the social networking site. The two users may also have a common interest.

### SUMMARY

The subject disclosure relates generally to associating a shared interest with a social relationship between users, and more particularly to annotating edges of a social graph that shows social relationships among users with information from interest graphs associated with the users.

The subject disclosure relates to a machine-implemented method that includes determining whether a social interaction between a first user and a second user includes a shared interest, where the shared interest identifies an interest about which the first user and the second user communicate in the social interaction, identifying a social relationship between the first user and the second user based at least on the social interaction, when the social interaction includes a shared interest, and associating the shared interest with the identified social relationship by referencing the shared interest in the identified social relationship between the first user and the second user.

These and other aspects can include one or more of the following features. The method may also include determining, based on the social interaction, a frequency score of the shared interest for the identified social relationship, and associating the frequency score with the shared interest and with the identified social relationship. The frequency score may be determined based on a total number of interactions between the first user and the second user that are associated with the shared interest.

The method may also include determining, based on the social interaction, a level of interest score of the shared interest for the identified social relationship and associating the level of interest score with the shared interest and with the identified social relationship. The level of interest score may be determined based on at least one of an interest level of at least one of the users, a type of communication associated with the social interaction, directionality of the social interaction, size of the audience of the social interaction, sentiment analysis, content of the social interaction, or uniqueness of the shared interest.

Additionally, a plurality of shared interests may be identified, and also the social interaction between the first user and the second user may comprise at least one of an email, an affirmation of content of the first user by the second user, a text message, a post, a comment on a post, or an instant message. The step of identifying a social relationship may also include identifying the social relationship on a social networking site. The identified social relationship may correspond to an edge that is shared between two nodes of a social graph, wherein the two nodes comprises a node corresponding to the first user and a node corresponding to the second user.

Further, whether the social interaction includes a shared interest may be determined based on analysis of the social interaction through text recognition. The shared interest may be stored in an interest graph of at least one of the first user or the second user. The method may also include suggesting content based at least on the shared interest and the identified social relationship.

The present disclosure also relates to a system that includes a shared interest determination module configured to determine whether a social interaction on a social networking site between a first user and a second user includes a shared interest, wherein the shared interest identifies an interest about which the first user and the second user communicate in the interaction. The system also includes a social relationship identification module configured to identify a social relationship between the first user and the second user based at least on the social interaction, when the social interaction includes a shared interest, wherein the social relationship is identified on a social networking site, and an association module configured to associate the shared interest with the identified social relationship by referencing the shared interest in the identified social relationship between the first user and the second user.

These and other aspects can include one or more of the following features. The system may also include a frequency score determination module configured to determine, based on the social interaction, a frequency score of the shared interest for the identified social relationship, wherein the association module is further configured to associate the frequency score with the shared interest and with the identified social relationship. The frequency score may be determined based on a total number of interactions between the first user and the second user that are associated with the shared interest.

Additionally, the system may also include an interest score determination module configured to determine, based on the social interaction, a level of interest score of the shared interest for the identified social relationship, wherein the association module is further configured to associate the level of interest score with the shared interest and with the identified social relationship. The level of interest score may be determined based on at least one of an interest level of at least one of the users, a type of communication associated with the social interaction, directionality of the social interaction, size of the audience of the social interaction, sentiment analysis, content of the social interaction, or uniqueness of the shared interest. The identified social relationship may also correspond to an edge that is shared between two nodes of a social graph, wherein the two nodes comprises a node corresponding to the first user and a node corresponding to the second user.

The present disclosure further relates to a machine-readable medium comprising instructions stored therein, which when executed by processors, cause the processors to perform operations that include determining whether a social interaction on a social networking site between a first user and a second user includes a shared interest, where the shared interest identifies an interest about which the first user and the second user communicate in the social interaction. The operations also include identifying a social relationship between the first user and the second user based at least on the social interaction, when the social interaction includes a shared interest. The identified social relationship corresponds to an edge that is shared between two nodes of a social graph, and the two nodes include a node corresponding to the first user and a node corresponding to the second user. The operations further include associating the shared interest with the identified social relationship by referencing the shared interest in the identified social relationship between the first user and the second user, and suggesting content based at least on the shared interest and the identified social relationship.

These and other aspects can include one or more of the following features. The shared interest may be stored in an interest graph of at least one of the first user or the second user.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 is a diagram of an example system for associating a shared interest with a social relationship between users.

FIG. 2 illustrates a flow diagram of an example process for associating a shared interest with a social relationship between users.

FIG. 3 conceptually illustrates diagrams showing an example social graph and an example interest graph.

FIG. 4 conceptually illustrates an example of a system for associating a shared interest with a social relationship between users.

FIG. 5 conceptually illustrates an electronic system with which some aspects of the subject technology are implemented.

### DETAILED DESCRIPTION

In the following detailed description, numerous specific details are set forth to provide a full understanding of the present disclosure. It will be apparent, however, that the implementations of the present disclosure may be practiced without some of these specific details. In other instances, structures and techniques have not been shown in detail so as not to obscure the disclosure.

Current social networking sites use a social graph to describe the relationships between users. Current social networking sites also use an interest graph to describe the relationships between users and topics of interest. Users in the social graph are represented by nodes, and the relationships between users are represented by edges. In the interest graph, users and topics of interest are represented by nodes, and relationships between users and topics of interest are represented by edges. From a social graph and an interest graph, a common interest can be inferred when two related users have a topic of interest in common. Some systems may not differentiate between an interest that is common to both users and an interest that is, in fact, shared (e.g., captured in communications) between the users. For example, two users who email one another may each be interested in a topic such as the Red Sox, but the users may have never discussed the Red Sox with one another. The current system may infer a common interest in Red Sox between the users although the users do not actually share their individual interests with one another.

Methods and systems for associating a shared interest with a social relationship between users are provided herein. The users may be users of a social networking site or users of other sites or services on the Web. The system may identify a social interaction between users. Examples of different types of social interactions include communications from one user to another user such as an email, an affirmation of content of the first user by the second user, a text message (e.g., a short message service), a post, a comment on a post, or an instant message.

The social interaction is used as a basis for identifying a new or pre-existing social relationship between the users at, for example, a social networking site. Based on the social interactions between the users, shared interests are also identified. Shared interests identify interests between the interacting users that are, in fact, shared by the users (e.g., communicated between the users), rather than merely common to the users. The identified shared interests are then associated with the social relationship of the interacting users.

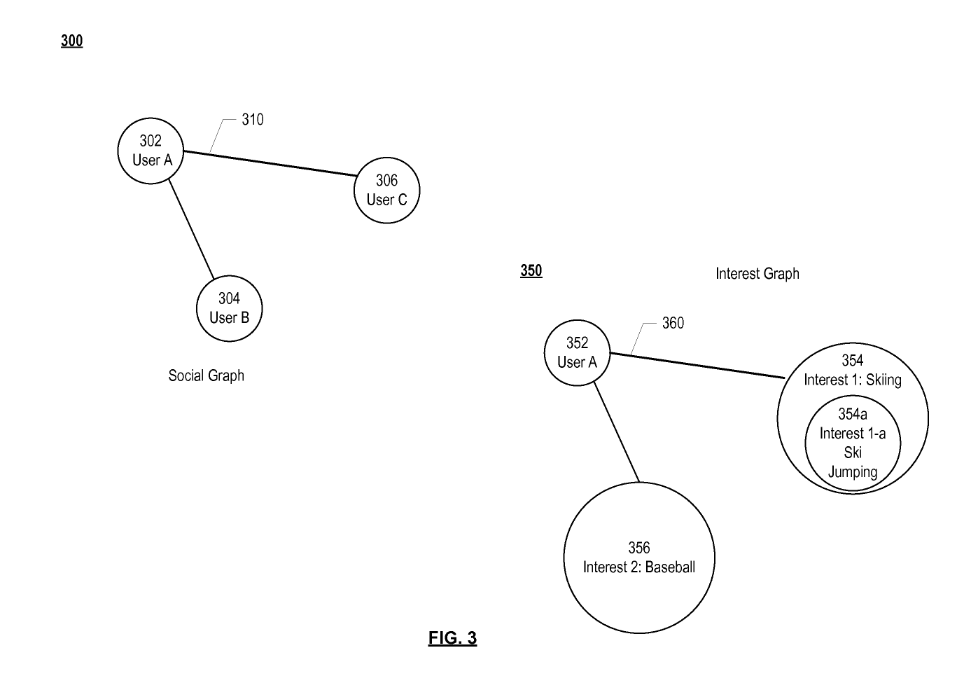

The identified social relationship may be stored as a social graph in which nodes represent the different users and edges connecting the nodes represent the social relationship between users. The identified shared interests that are associated with the social relationship of the interacting users may also be stored in an interest graph for each of the interacting users. An interest graph stores information on interests that are associated with a user. Therefore, the identified shared interest may be associated with the social relationship between the users by annotating the shared edge of the social graph with a link to the interest graphs of the users that contain the shared interests. The social graph and the interest graph are discussed in more detail below, with respect to FIG. 3.

The phrase “social networking site” as used herein encompasses its plain and ordinary meaning, including, but not limited to, an online service, platform or site that focuses on building and reflecting of social relationships and interactions among users. Users of the social network may create social relationships with one another (e.g., identify other users as friends). Such relationships may be defined on a user-to-user basis, or as a group of users associated through membership within a group. The social relationships may be stored in a social graph that may be maintained on the social networking site. The social relationships between users may be symmetrical or asymmetrical.

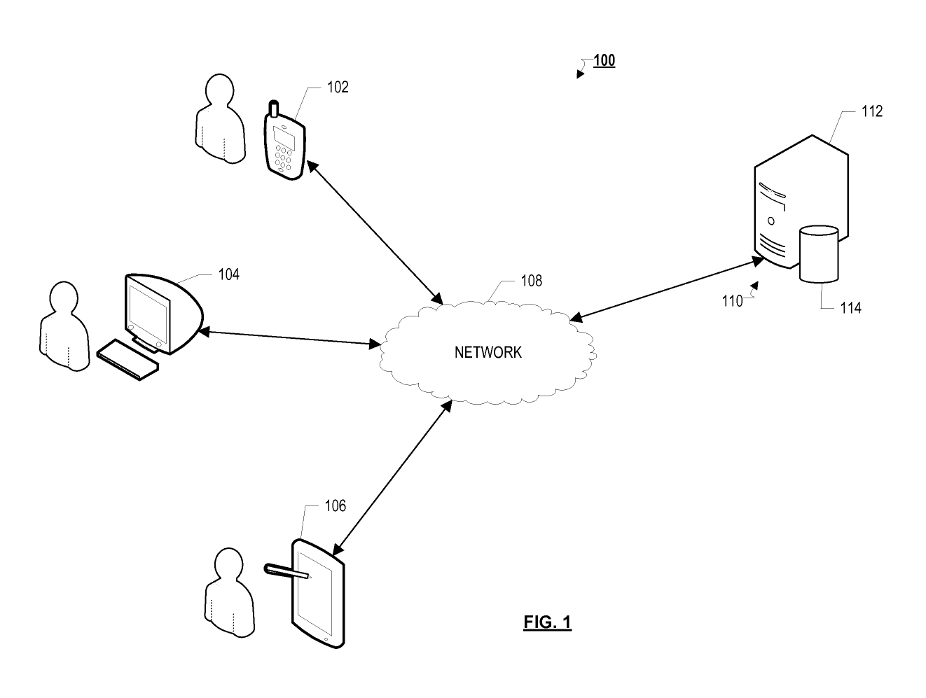

FIG. 1 illustrates an example client-server network that provides for associating a shared interest with a social relationship between users. A network display 100 includes a number of electronic devices 102, 104 and 106 communicably connected to a server 110 by a network 108. Server 110 includes a processing device 112 and a data store 114. Processing device 112 executes computer instructions stored in data store 114, for example, instructions to determine whether a social interaction between a first user and a second user includes a shared interest, where the shared interest identifies an interest about which the first user and the second user communicate in the social interaction, identify a social relationship between the first user and the second user based at least on the social interaction, when the social interaction includes a shared interest, and associate the shared interest with the identified social relationship by referencing the shared interest in the identified social relationship between the first user and the second user.

Data store 114 may store information pertaining to, for example, the social interaction between the first and second users. Data store 114 may also store the social graph and/or the interest graph. Server 110 may host an application within which some of the processes discussed herein are implemented. In some example aspects, electronic devices or client devices, as used interchangeably herein, 102, 104 and 106 can be computing devices such as smartphones, PDAs, portable media players, tablet computers, televisions or other displays with one or more processors coupled thereto or embedded therein, or other appropriate computing devices that can be used for running a mobile application (e.g., a mobile application for accessing a social networking site).

Electronic devices 102, 104 and 106 may have one or more processors embedded therein or attached thereto, or other appropriate computing devices that can be used for accessing a host, such as server 110. For example, the server 110 may host a social networking site, and users of the social networking site may access the social networking site using any of the electronic devices 102, 104 or 106 to access the social networking site to share interests with other users. In the example of FIG. 1, electronic device 102 is depicted as a smartphone, electronic device 104 is depicted as a tablet computer, and electronic device 106 is depicted as a PDA. A client is an application or a system that accesses a service made available by a server which is often (but not always) located on another computer system accessible by a network. Some client applications may be hosted on a website, whereby a browser is a client. Such implementations are within the scope of the subject disclosure, and any reference to client may incorporate a browser and reference to server may incorporate a website.

The system (e.g., hosted at server 110), determines whether a social interaction between users (e.g., between User A and User B) includes a shared interest. The users may be, for example, users of a social networking site. The users may interact with any of the electronic devices 102, 104 or 106 to interact with the system to generate the social interaction. The shared interest identifies an interest that is, in fact, communicated between the users in the social interaction, rather than being merely common to the users. For example, a shared interest may be identified from an interaction between User A and User B when the users discuss with each other a topic, such as, for example, “skiing.” Thus, “skiing” may be deemed a shared interest. However, when it is observed that User A has posted about “painting,” and User B has, likewise, posted about “painting” but users A and B have never discussed the topic of “painting” together, “painting” may be deemed a common interest, but not a shared interest. One or more shared interests may be identified from the social interaction and associated with other shared interests in a hierarchical form. The shared interests from multiple levels of the hierarchy may be associated with a single social interaction.

When the social interaction between the users includes a shared interest, the system identifies a social relationship between the users based at least on the social interaction. As shown in FIG. 3, the identified social relationship may be represented by a shared edge between nodes on a social graph, where each node corresponds to a different user. The social graph may be stored, for example, in the data store 114. In an aspect of the subject technology, if no pre-existing social relationship exists between the users (e.g., the users have not previously interacted with each other), a new social relationship may be established by creating a new shared edge between the users' nodes on the social graph. Also, the social interactions may be interaction between any number of users, including, but not limited to, interactions between two users, and interactions between a single user and a group of users. Interactions originating from one user and sent to a group of users may be used as a basis for identifying a social relationship from the originating user to the group entity, in addition to identifying social relationships between the originating user and each member of the group.

The system also associates the shared interest with the identified social relationship by referencing the shared interest in the identified social relationship between the users. For example, the shared interest may be stored as annotations to the shared edge between nodes of the social graph that correspond to the users (e.g., a shared edge that connects a node corresponding to User A and a node corresponding to User B). In addition to associating the identified shared interest with the social relationship of the users, the system may further evaluate the social interaction between the users to identify a level of interest for the shared interest. Also, the total number of interactions regarding a certain topic may be recorded to determine the frequency with which the users discuss the shared interest. The level of interest and the frequency may be expressed as scores that are also included in the annotation to the shared edge between nodes of the users. A frequency score and a level of interest score may be updated for each shared interest that is associated with a social relationship between the users.

Each electronic device 102, 104 and 106 may be a client device or a host device. In some example aspects, server 110 can be a single computing device such as a computer server. In other implementations, server 110 can represent more than one computing device working together to perform the actions of a server computer (e.g., cloud computing). The server 110 may host the web server communicationally coupled to the browser at the client device (e.g., electronic devices 102, 104 or 106) via network 108.

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

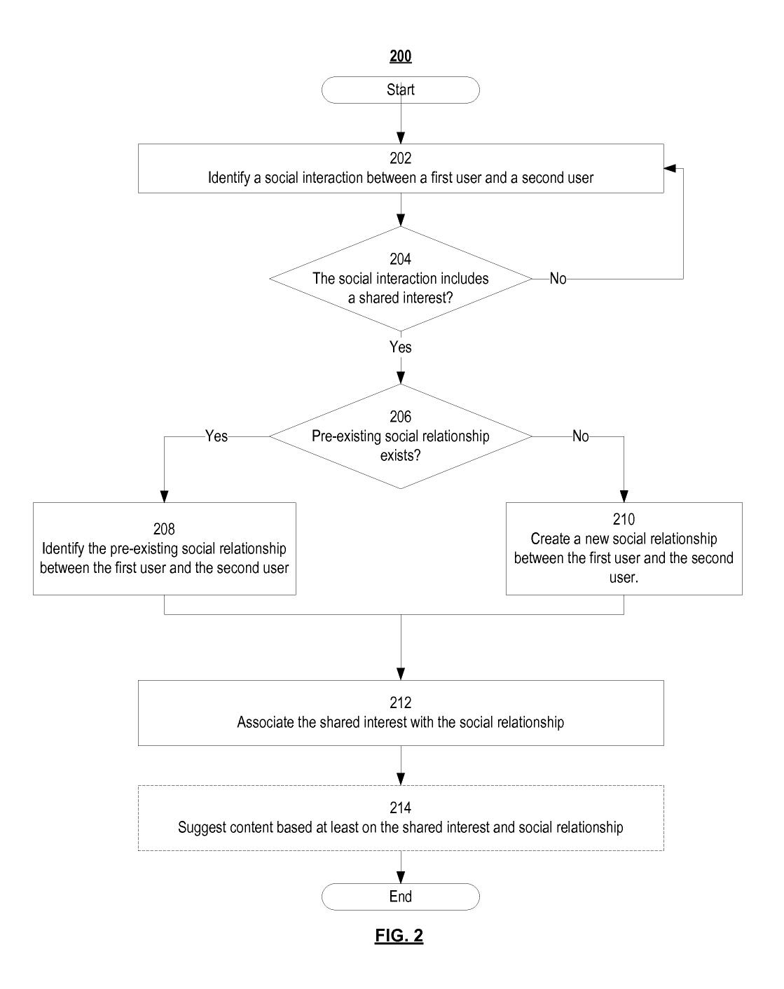

FIG. 2 illustrates a flow diagram of an example process 200 for associating a shared interest with a social relationship between users. Process 200 may be performed, for example, by the system discussed above which may be hosted at server 110 of FIG. 1. Process 200 begins and at block 202, the system identifies a social interaction between a first user and a second user. The first and second users may be, for example, users of a social networking site or other sites or services on the Web. The first and second users may access the system, for example, using any of the electronic devices 102, 104 or 106 of FIG. 1. The social interaction may be, for example, communications between the first and second user such as an email, affirmation of content, a text message (e.g., a short message service), a post, a comment on a post, or an instant message.

At block 204, the system determines whether the social interaction identified at block 202 between the first user and the second user includes a shared interest. The shared interest identifies an interest about which the first user and the second user communicate in the social interaction. For example, the social interaction may be the second user's comment on the first user's post about the first user's attendance to a skiing event. The second user's comment may indicate a second user's desire to attend the skiing event as well. The system may determine from the second user's comment on the first user's post that both the first and second users have skiing as a shared interest. Because the first and second users have communicated with each other about skiing, skiing is an interest about which both users have actually shared with each other, rather than an interest that happens to be a common interest to both users (but that has not been necessarily shared between the two users). A shared interest between the two users is more likely to be relevant to the relationship between the two users, than a common interest.

The shared interest may be stored in an interest graph for each of the two users. As shown in FIG. 3, an interest graph stores information on interests that are associated with a user. For example, the interest graph may include a node representing a user, and one or more nodes representing interests that are associated with the user. Edges connect the user node and the interest nodes that are associated with the user. The interest graph may be stored, for example, at the data store 114.

The system may analyze the content of the social interaction through text recognition techniques to determine whether the social interaction identified at block 202 includes a shared interest. In the example above, the system may perform a text recognition on the second user's comment and the first user's post to determine that the interaction discusses the shared interest on skiing. Other types of techniques for analyzing the content of the interaction may also be used.

If the interaction identified at block 202 is determined at block 204 to include a shared interest, at block 206, the system determines whether a pre-existing social relationship exists between the first and the second users. The social relationship may be stored at a social graph. As shown in FIG. 3, the social graph includes nodes representing different users, and relationships between the different users may be represented as edges connecting the nodes of the users. To determine the existence of a pre-existing social relationship at block 206, for example, the system may search the social graph to determine the whether a pre-existing social relationship exists. The social graph may be stored, for example, at data store 114. If a social relationship already exists between the first and the second users (e.g., the two users have previously interacted with each other), the system identifies, at block 208, the pre-existing social relationship. If the system determines at block 206 that no pre-existing relationship exists between the two users (e.g., the two users have not interacted with each other before), the system creates, at block 210, a new social relationship between the first user and the second user. In the example above, the system creates a new edge connecting the nodes corresponding to the first and second users in the social graph. If the interaction identified at block 202 is an interaction between a single user and a group of users, a social relationship may be created between the single user and a group of users, and separate social relationships may also be created between the single user and each member of the group.

At block 212, the system associates the shared interest with the social relationship that is either identified at block 208 or created at block 210, depending on the system's determination at block 206. The system performs the association by referencing the shared interest in the identified social relationship between the first user and the second user. For example, the system may reference the shared interest by storing the shared interest as annotations to the edge between the first user node and the second user node of the social graph. The annotations may be one or more links which points to the interest graphs for the first user and/or second user which stores the shared interest.

However, if the interaction identified at block 204 does not include a shared interest, process 200 reverts back to block 202. For example, the system may analyze the content of the social interaction (e.g., by text recognition), but may not be able to identify any shared interests. Specifically, the second user's comment on the first user's post about attending a skiing event may indicate that the second user does not like skiing. In such case, the process reverts back to block 202 and the system may move on to identifying another social interaction.

In an aspect of the subject technology, the shared interests that are associated with the social relationships include additional properties. Such properties include a frequency score and a level of interest score. The frequency score indicates how many social interactions occur between the users that are associated with the shared interest. The frequency score may associate different weights to social interactions over time so that shared interests identified from recent social interactions are scored more highly than those from less recent social interactions. Therefore, a high frequency score may indicate that the users have recently communicated frequently on the shared interest such that, as compared to a shared interest having a lower frequency score, it is more likely that the users will communicate on the high-frequency-score-shared interest in the near future.

In determining the frequency score, the system may evaluate the social interaction identified at block 202 and/or previous social interactions between the first and second users to identify a frequency at which the two users interacted on the shared interest. Specifically, the system may count the total number of interactions between the first and second users regarding the shared interest. The counted number of interactions may be used as basis for determining the frequency score. The system may also give different weights to the social interactions over time, so that shared interests identified from recent social interactions are scored more highly.

In determining the level of interest score, as with the frequency score, the system may also evaluate the social interaction identified at block 202 and/or previous social interactions between the first and second users to identify a level of interest for the shared interest that is communicated in the social interaction. Based on the evaluation of the social interaction, the system may consider various factors in determining the level of interest score. Such factors include, but are not limited to: an interest level of at least one of the users (e.g., indications of high individual interest of each user in a relationship as it relates to each user's individual interest graph may indicate a higher level of interest for the level of interest score of the relationship between the users), a type of communication associated with the social interaction (e.g., emails that are exchanged between one user and a single other user may indicate more interest than a post that is published to a large group of users), the directionality of the social interaction (e.g., components of the level of interest score may indicate that one user initiates interactions), size of the audience of the social interaction (e.g., an email sent from one user to a single other user may indicate more interest in the topic between the users than an email sent to a list of recipients), sentiment analysis (e.g., whether the social interaction indicates affinity or distaste for the shared interest), content of the social interaction (e.g., plans to purchase concert tickets together or discussion of going to an event in an email may indicate more interest than a general discussion of the topic during an instant messaging conversation), or uniqueness of the topic (e.g., shared niche interests may indicate more interest than widely held interests of the community).

In an aspect of the subject technology, the system may also suggest, at block 214, content based on the shared interests which is included in the social interaction identified at block 202 and/or based on the social relationship that is either identified at block 208 or created at block 210. The suggested content may include, for example, web pages, posts, event information, offers, discussion forums, mailing lists and group chat sessions. A suggestion may be made to a user to share the suggested system content with another user based on the frequency score or the level of interest score. A suggestion may include a suggestion to forward content, a suggestion to invite another user to an event, a suggestion to purchase an offer as a gift for another user, and the like. For example, the system may suggest the first user to invite the second user to attend a skiing class, if the social relationship of the first and second user is associated with the shared interest “skiing” with high frequency and level of interest scores.

FIG. 3 conceptually illustrates diagrams showing an example social graph and an example interest graph. Diagram 300 shows an example social graph. The social graph includes nodes 302, 304 and 306 corresponding to users A, B and C, respectively. Edges between the different nodes represent social relationships that exist between the users corresponding to the node. Diagram 300 shows that an edge 310 exists between node 302 and node 306, denoting that a social relationship exists between user A and user C. The edge 310 may be annotated with a shared interest between user A and user C that the system may have identified. The shared interest annotation may be a link or links that point to an interest graph or interest graphs of user A and/or B containing a node corresponding to the shared interest. The annotation may also include a frequency score and/or a level of interest score associated with the shared interest and the social relationship between users A and C.

Diagram 350 shows an example interest graph for user A. The interest graph includes a user node 352 representing user A. The interest graph also includes different interest nodes, such as interest nodes 354 and 356 that correspond to different interests that may be associated with user A. The interests may be topics that user A or other users may find interesting. An edge between the user node 352 and an interest node represents that an association has been previously made between the user and the interest represented by the nodes. Diagram 350 shows that interest node 354 represents the topic “skiing”, and interest node 356 represents the topic “baseball.” Diagram 350 also shows that an edge 360 exists between user node 352 and the interest node 354. Therefore, edge 360 denotes that an association has been previously made between user A and the topic skiing, suggesting that user A may find the topic “skiing” interesting.

The interest nodes may be organized hierarchically. For example, the interest node 354 represents the topic “skiing,” and the interest node may have a sub node 354a representing “ski jumping.” An edge may connect with the parent node, which may automatically connect with the sub nodes. The edge may also specifically connect with the sub node.

Edge 360 may also be annotated with information which identifies social relationships with which the interest represented by the interest node is associated. For example, edge 360 may be annotated with information indicating that the social relationship represented by the edge 310 has skiing annotated as a shared interest between users A and C. Edge 360 may also be annotated with information on other social relationships that have skiing annotated as shared interest.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing display. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

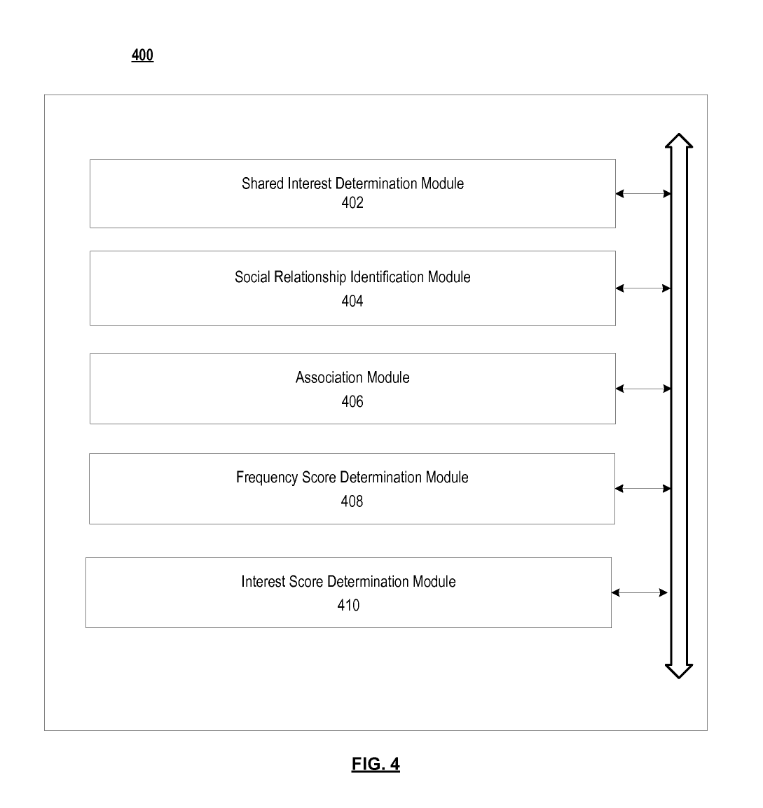

FIG. 4 illustrates an example of system 400 for associating a shared interest with a social relationship between users, in accordance with various aspects of the subject technology. System 400 comprises a shared interest determination module 402, a social relationship identification module 404, and an association module 406. The system 400 may also comprise a frequency score determination module 408 and an interest score determination module 410.

The shared interest determination module 402 is configured to determine whether an interaction between a first user and a second user includes a shared interest, where the shared interest identifies an interest about which the first user and the second user communicate in the interaction. The social relationship identification module 404 is configured to identify a social relationship between the first user and the second user based at least on the interaction, when the identified interaction includes a shared interest. The association module 406 is configured to associate the shared interest with the identified social relationship by referencing the shared interest in the identified social relationship between the first user and the second user.

The frequency score determination module 408 is configured to determine a frequency score of the shared interest for the social relationship identified by the social relationship identification module 404. The frequency score may be determined based on the interaction between the first user and the second user. The frequency score may be determined based on a total number of interactions between the first user and the second user that are associated with the shared interest. The interest score determination module 410 is configured to determine a level of interest score of shared interest associated with the social relationship identified by the social relationship identification module 404. The level of interest score may be determined based on the interaction between the first user and the second user. The level of interest score may be determined based on at least one of an interest level of at least one of the first and second users, a type of communication associated with the interaction between the first and second users, directionality of the interaction, size of the audience of the interaction, sentiment analysis, content of the interaction, or uniqueness of the shared interest.

These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

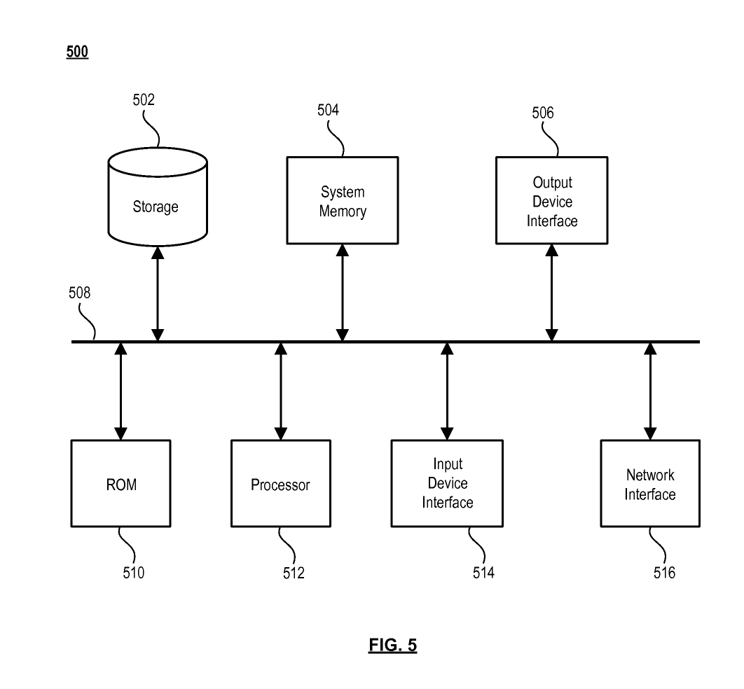

FIG. 5 conceptually illustrates an electronic system with which some aspects of the subject technology are implemented. Electronic system 500 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as televisions or other displays with one or more processors coupled thereto or embedded therein, or other appropriate computing devices that can be used for running an application. Some implementations include devices such as a touch screen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a device having a display device, e.g., televisions or other displays with one or more processors coupled thereto or embedded therein, or other appropriate computing devices that can be used for running an application, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. A computer-implemented method comprising:
determining that a social interaction between a first user and a second user includes a shared interest, wherein the shared interest identifies an interest about which the first user and the second user communicate in the social interaction;
identifying an edge shared between a first node and a second node of a social graph stored in a data store based at least on the social interaction, the social graph identifying an interconnection of nodes corresponding to social relationships between users of a social network, the first node of the social graph representing the first user and the second node of the social graph representing the second user, the edge corresponding to a social relationship between the first user and the second user;
annotating the edge of the social graph with an indication of the shared interest to associate the shared interest with the social relationship between the first user and the second user, the indication of the shared interest indicating a total number of interactions between the first user and the second user with respect to the shared interest, the annotated edge of the social graph comprising a link to a location in the data store where an interest graph is stored, the interest graph identifying an interconnection between a first node and a second node of the interest graph, the first node of the interest graph representing the shared interest and the second node of the interest graph representing at least one of the first user or the second user; and
providing suggested content associated with the shared interest to the first user, the suggested content including an indication to the first user to share the suggested content with the second user based on the indication of the shared interest of the annotated edge of the social graph.

2. The computer-implemented method of claim 1, further comprising:
determining, based on the social interaction, a frequency score of the shared interest for the identified edge corresponding to the social relationship; and
associating the frequency score with the shared interest and with the identified edge of the social graph.

3. The computer-implemented method of claim 2, wherein the frequency score is determined based on the total number of interactions between the first user and the second user that are associated with the shared interest.

4. The computer-implemented method of claim 1, further comprising:
determining, based on the social interaction, a level of interest score of the shared interest for the identified edge corresponding to the social relationship; and
associating the level of interest score with the shared interest and with the identified edge of the social graph.

5. The computer-implemented method of claim 4, wherein the level of interest score is determined based on at least one of an interest level of at least one of the users, a type of communication associated with the social interaction, directionality of the social interaction, size of the audience of the social interaction, sentiment analysis, content of the social interaction, or uniqueness of the shared interest.

6. The computer-implemented method of claim 1, wherein a plurality of shared interests are identified.

7. The computer-implemented method of claim 1, wherein the social interaction between the first user and the second user comprises at least one of an email, an affirmation of content of the first user by the second user, a text message, a post, a comment on a post, or an instant message.

8. The computer-implemented method of claim 1, wherein the step of identifying the edge comprises obtaining access to the stored social graph associated with a social networking site.

9. (canceled)

10. The computer-implemented method of claim 1, wherein whether the social interaction includes a shared interest is determined based on analysis of the social interaction through text recognition.

11. The computer-implemented method of claim 1, wherein the shared interest is stored in an interest graph of at least one of the first user or the second user.

12. (canceled)

13. A system comprising:
a memory storing executable instructions; and
one or more processors configured to execute the executable instructions stored in the memory, which when executed by the one or more processors, cause the one or more processors to perform operations comprising:
determining that a social interaction on a social networking site between a first user and a second user includes a shared interest, wherein the shared interest identifies an interest about which the first user and the second user communicate in the interaction;
identifying an edge shared between a first node and a second node of a social graph stored in a data store based at least on the social interaction, the social graph identifying an interconnection of nodes corresponding to social relationships between users of a social network, the first node of the social graph representing the first user and the second node of the social graph representing the second user, the edge corresponding to a social relationship between the first user and the second user;
annotating the edge of the social graph with an indication of the shared interest to associate the shared interest with the social relationship between the first user and the second user, the indication of the shared interest indicating a total number of interactions between the first user and the second user with respect to the shared interest, the annotated edge of the social graph comprising a link to a location in the data store where an interest graph is stored, the interest graph identifying an interconnection between a first node and a second node of the interest graph, the first node of the interest graph representing the shared interest and the second node of the interest graph representing at least one of the first user or the second user; and
providing suggested content associated with the shared interest to the first user, the suggested content including an indication to the first user to share the suggested content with the second user based on the indication of the shared interest of the annotated edge of the social graph.

14. The system of claim 13, wherein the operations further comprise:
determining, based on the social interaction, a frequency score of the shared interest for the identified edge corresponding to the social relationship, and
associating the frequency score with the shared interest and with the identified edge of the social graph.

15. The system of claim 14, wherein the frequency score is determined based on the total number of interactions between the first user and the second user that are associated with the shared interest.

16. The system of claim 13, wherein the operations further comprise:
determining, based on the social interaction, a level of interest score of the shared interest for the identified edge corresponding to the social relationship, and
associating the level of interest score with the shared interest and with the identified edge of the social graph.

17. The system of claim 16, wherein the level of interest score is determined based on at least one of an interest level of at least one of the users, a type of communication associated with the social interaction, directionality of the social interaction, size of the audience of the social interaction, sentiment analysis, content of the social interaction, or uniqueness of the shared interest.

18. (canceled)

19. A machine-readable medium comprising instructions stored therein, which when executed by processors, cause the processors to perform operations comprising:
determining that a social interaction on a social networking site between a first user and a second user includes a shared interest, wherein the shared interest identifies an interest about which the first user and the second user communicate in the social interaction;
identifying a social relationship between the first user and the second user based at least on the social interaction, wherein the identified social relationship corresponds to an edge that is shared between two nodes of a social graph, the two nodes of the social graph comprising a node corresponding to the first user and a node corresponding to the second user;
annotating the edge of the social graph with an indication of the shared interest to associate the shared interest with the social relationship between the first user and the second user, the indication of the shared interest indicating a total number of interactions between the first user and the second user with respect to the shared interest, the annotated edge of the social graph comprising a link to a location in a data store where an interest graph is stored, the interest graph identifying an interconnection between a first node and a second node of the interest graph, the first node of the interest graph representing the shared interest and the second node of the interest graph representing at least one of the first user or the second user; and
providing suggested content associated with the shared interest to the first user, the suggested content including an indication to the first user to share the suggested content with the second user based on the indication of the shared interest of the annotated edge of the social graph.

20. The machine-readable medium of claim 19, wherein the shared interest is stored in an interest graph of at least one of the first user or the second user.

21. The computer-implemented method of claim 1, wherein the interest graph is stored independent of the social graph in the data store.

22. The computer-implemented method of claim 1, wherein the annotated edge of the social graph comprises a link to a first interest graph and a second interest graph, the first interest graph identifying an interconnection between a first node and a second node of the first interest graph, the first node of the first interest graph representing the shared interest and the second node of the first interest graph representing the first user, the second interest graph identifying an interconnection between a third node and a fourth node of the second interest graph, the third node of the second interest graph representing the shared interest and the fourth node of the second interest graph representing the second user.

23. The computer-implemented method of claim 1, wherein the first node of the interest graph includes a sub node representing a sub topic for the shared interest.
